(19) United States
(12) Patent Application Publication
(10) Pub. No.: US 2021/0276609 A1
(43) Pub. Date: Sep. 9, 2021

(54) Steering System, Method for Operating a Steering System and Steering System

(71) Applicant: Robert Bosch GmbH, Stuttgart (DE)

(72) Inventors: Denes Gacsal, Eger (HU); Gabor Andor Fuchs, Felsoezsolca (HU); Miklos Szabo, Eger (HU)

(21) Appl. No.: 16/347,527

(22) PCT Filed: Oct. 17, 2017
(86) PCT No.: PCT/EP2017/076394

§ 371 Date: May 3, 2019

(30) Foreign Application Priority Data
Nov. 4, 2016 (DE) 10 2016 121 043.9

(51) Int. Cl. B62D 1/19

(52) U.S. Cl. CPC B62D 1/195

(57) ABSTRACT

A steering system for a motor vehicle includes at least one securing member and a first bearing device. The securing member releases the first bearing device from a fastening in the first position when applying a predetermined force on the first bearing device and the first bearing device can be moved into a second position.

The invention relates to a steering system for a motor vehicle. The invention furthermore relates to a method for operating a steering system for a motor vehicle. The invention moreover relates to a motor vehicle having the steering system according to the invention.

### PRIOR ART

Steering column brackets, which may be designed to be fixed or else adjustable, are well known. Owing to the arrangement of a steering wheel relative to the driver, in particular of a utility vehicle, there is a risk of injury in the event of a frontal collision of the motor vehicle. Although, for example, airbag devices which are installed in a steering wheel of the utility vehicle are known, it would likewise be desirable to change the position of the steering wheel relative to the driver in the event of the frontal collision such that a risk of injury of the driver is reduced.

DE 10 2009 001 324 A1 discloses a steering column bracket with a carrier housing for a steering column, which is mounted in an at least rotationally movably arranged steering column receptacle, whereby at least the inclination of the steering column is variable, and wherein at least a first detent engagement means and a second detent engagement means are provided which are connectable to the carrier housing, and in that a quick-action clamping device is provided for the detent engagement in one of the detent engagement means, whereby the steering column can be engaged with detent action in a first inclination position or in a second inclination position.

The above-mentioned device is however not suitable, in the event of a frontal collision of the motor vehicle, for adjusting the steering column in terms of its position in the short time interval available such that the risk of injury to the driver is reduced.

It is therefore desirable to provide a steering column bracket or a corresponding device which makes it possible for a position of the steering column relative to the driver of a motor vehicle, in particular of a utility vehicle, to be adjusted relative to the driver in the event of a frontal collision such that the risk of injury to the driver is reduced.

Said object is achieved by means of a steering system for a motor vehicle having the features of patent claim 1. The object is furthermore achieved by means of a method for operating a steering system for a motor vehicle having the features of patent claim 14. The object is moreover achieved by means of a motor vehicle having the steering system according to the invention having the features of patent claim 15.

### DISCLOSURE OF THE INVENTION

The present invention provides a steering system for a motor vehicle, having a steering column arranged in a steering column housing, a first mounting device in which the steering column housing of the steering column is adjustably mounted, wherein a second mounting device in which the first mounting device is adjustably mounted, wherein the second mounting device fastens the first mounting device in a first position by fastening means, and wherein, when a predefined force acts on the first mounting device, the fastening means release the first mounting device from a fastening in the first position, and the first mounting device is movable into a second position.

The invention furthermore provides a method for operating a steering system for a motor vehicle. The method comprises providing a steering column arranged in a steering column housing, providing a first mounting device in which the steering column housing of the steering column is adjustably mounted, and providing a second mounting device in which the first mounting device is adjustably mounted.

The method moreover comprises fastening the first mounting device by fastening means of the second mounting device, releasing the first mounting device from a fastening in the first position, when a predefined force acts on the first mounting device, by the fastening means, and moving the first mounting device into a second position.

The invention moreover provides a motor vehicle having the steering system according to the invention, wherein the second mounting device is installed positionally fixedly in the motor vehicle.

It is a concept of the present invention, through the provision of the second mounting device in which the first mounting device is adjustably mounted, to adjust a longitudinal adjustability, that is to say an adjustability of the first mounting device with the steering column arranged therein, in a particular direction with a longitudinal component such that improved and/or expanded adjustability of the first mounting device is made possible.

In particular, it is advantageous here that the second mounting device makes it possible for the first mounting device to be fastened in a first position in a first operating state, that is to say in a rest state or during normal operation of the motor vehicle, and wherein, in the event of a frontal collision, when a predefined force, that is to say a force which lies above a predefined threshold, acts on the first mounting device, the first mounting device can be released from the fastening in the first position, and the first mounting device is movable from the first, fastened position into a second position, wherein the second position is a protection position in which the first mounting device with the steering column arranged therein is positioned such that the driver of the motor vehicle has a reduced risk of injury in the event of the frontal collision.

Advantageous embodiments and refinements will emerge from the subclaims and from the description with reference to the figures.

In a further preferred refinement, provision is made whereby the second mounting device has a first side wall and a second side wall, between which the first mounting device is arranged, wherein the first mounting device has a first guide element which is formed adjacent to the first side wall of the second mounting device, wherein the second mounting device has a second guide element which is in engagement with the first guide element, wherein the first mounting device has a third guide element which is formed adjacent to the second side wall of the second mounting device, and wherein the second mounting device has a fourth guide element which is in engagement with the third guide element. The second mounting device is thus designed such that the first mounting device can be guided between respective side walls of the second bearing device. The mounting of the first mounting device with the steering column arranged therein in the second mounting device is thus entirely independent of an adjustability of the steering column in the first mounting device. By means of this independence, it can be ensured that fast-reacting adjustability of the steering column is ensured in the event of a frontal collision.

According to a further preferred refinement, provision is made whereby the first guide element of the first mounting device is formed by a projection which extends substantially perpendicularly from an outer surface of the first mounting device, wherein the second guide element of the second mounting device is formed by a receiving means which surrounds the projection, wherein the third guide element of the first mounting device is formed by a projection which extends substantially perpendicularly from the outer surface of the first mounting device, and wherein the fourth guide element of the second mounting device is formed by a receiving means which surrounds the projection. By virtue of the fact that both the first guide element, which is formed as a projection, and the second guide element, which is formed as a receiving means, wherein the receiving means surrounds the projection, and wherein both the projection and the receiving means are arranged on the outer surface of the respective side walls or on the outer surface of the first bearing device, the body of the first bearing device can be guided in the second bearing device without structural or design modifications.

According to a further preferred refinement, provision is made whereby the projection has a metal sheet in looped form with two elongate portions arranged parallel to one another, wherein mutually adjacently arranged first end portions and second end portions of the two elongate portions arranged parallel to one another are connected to one another by respective arcuate portions. The projection is thus suitable, owing to its form, for being guided along a longitudinal direction on a corresponding counterpart of the second guide element.

According to a further preferred refinement, provision is made whereby the receiving means that surrounds the projection has substantially two elongate portions arranged parallel to one another, wherein mutually adjacently arranged first end portions of the two elongate portions arranged parallel to one another are connected to one another by an arcuate portion, and wherein mutually adjacently arranged second end portions of the two elongate portions arranged parallel to one another are not connected to one another. Owing to the shaping of the receiving means which surrounds the projection, the projection and the receiving means substantially exhibit positive locking. The projection or the first mounting device with the corresponding projection can thus be guided relative to or in the receiving means of the second mounting device.

In a further preferred refinement, provision is made whereby at least one of the two elongate portions, arranged parallel to one another, of the second guide element of the second mounting device has an aperture of substantially elongate form on an inner side arranged adjacent to the first guide element of the first mounting device, wherein, on the second end portion, on an outer surface of the first guide element of the first mounting device, there is formed a projection which extends into the aperture, and wherein an axial end portion of the aperture forms a stop of the projection during a movement of the first mounting device from the first position into the second position. It is thus advantageously possible that, in the event of the frontal collision of the motor vehicle, the first mounting device can be guided in the second mounting device from the first position into the second position, and the second position forms a stop. The first mounting device can thus be guided in the second mounting device along a controlled path.

According to a further preferred refinement, provision is made whereby the fastening means of the first mounting device have in each case one plate element and at least one pressure-exerting element, wherein the plate element can be pressed by means of the at least one pressure-exerting element against the outer surface of the first mounting device. It is thus advantageously possible by means of the plate element for a uniform contact pressure to be applied to the surface of the first mounting device.

According to a further preferred refinement, provision is made whereby the at least one pressure-exerting element is formed by a screw which is fitted into an opening which is formed in the second mounting device and which is equipped with an internal thread, wherein, by adjustment of the screw, a clamping force of the plate element onto the outer surface of the first mounting device is variable. The clamping force of the plate element onto the outer surface of the mounting device is thus variable, and adaptable to corresponding requirements with regard to a release force for the release of the first mounting device from the fastening of the second mounting device, by tightening or loosening the screw.

According to a further preferred refinement, provision is made whereby the outer surface of the first mounting device has a wedge form in the region of the fastening means, wherein a thickness of the wedge form increases in a direction of movement of the first mounting device from the first position to the second position. During the movement of the first mounting device relative to the second mounting device from the first position toward the second position, the gap thus forms between the pressure-exerting element and the first mounting device immediately after the release of the first mounting device from the fastening by the second mounting device in the first position, whereby the first mounting device can thus advantageously move in the direction of the second position in unbraked fashion.

According to a further preferred refinement, provision is made whereby, when a force of ≥3500 N acts on the first mounting device, the fastening means release the first mounting device from the fastening in the first position, and the first mounting device is movable into the second position. It is thus possible, by corresponding adjustment of the fastening means, to set a release threshold at which the first mounting device can be released from the fastening in the second mounting device.

According to a further preferred refinement, provision is made whereby a movement of the first mounting device out of the fastening from the first position into the second position has a movement component in a vehicle longitudinal direction of at least 90 mm. It is thus possible for the steering column, and the steering wheel connected to said steering column, of the motor vehicle to be moved in an advantageous manner from the first position, which typically forms a driving position of the motor vehicle, into the second position, which forms a safety position in the event of the frontal collision of the motor vehicle, wherein there is an adequate longitudinal spacing between the first position and the second position.

According to a further preferred refinement, provision is made whereby the first side wall and the second side wall of the second mounting device are connected to one another by a connecting element. The second mounting device thus advantageously exhibits a required stability or strength in order to reliably guide the first mounting device therein in the presence of correspondingly high acting forces or loads.

The described embodiments and refinements may be combined with one another in any desired manner.

Further possible embodiments, refinements and implementations of the invention also encompass combinations, which have not explicitly been mentioned, of features of the invention described above or below with regard to the exemplary embodiments.

### BRIEF DESCRIPTION OF THE DRAWINGS

The appended drawings are intended to impart further understanding of the embodiments of the invention. They illustrate embodiments and, in conjunction with the description, serve for explaining principles and concepts of the invention.

Other embodiments and many of the stated advantages will emerge with regard to the drawings. The illustrated elements of the drawings are not necessarily shown in proportion relative to one another.

In the drawings:

FIG. 1 is a schematic illustration of a steering system for a motor vehicle according to a preferred embodiment of the invention;

FIG. 2 is a schematic illustration of the first and second mounting device according to the invention according to the preferred embodiment of the invention;

FIG. 3 is a schematic illustration of the first and second mounting device according to the invention according to the preferred embodiment of the invention;

FIG. 4 is a schematic illustration of fastening means for the fastening of the first mounting device to the second mounting device according to the preferred embodiment of the invention;

FIG. 5 is a schematic illustration of fastening means for the fastening of the first mounting device to the second mounting device according to the preferred embodiment of the invention;

FIG. 6 is a schematic illustration of a first guide element of the first mounting device and of a second guide element of the second mounting device according to the preferred embodiment of the invention;

FIG. 7 is a schematic illustration of a wedge form of the first mounting device according to the preferred embodiment of the invention;

FIG. 8 is a schematic illustration of a wedge form of the first mounting device according to the preferred embodiment of the invention; and

FIG. 9 shows a flow diagram of a method for operating the steering system for the motor vehicle according to the preferred embodiment of the invention.

In the figures of the drawings, the same reference designations denote identical or functionally identical elements, parts or components unless stated otherwise.

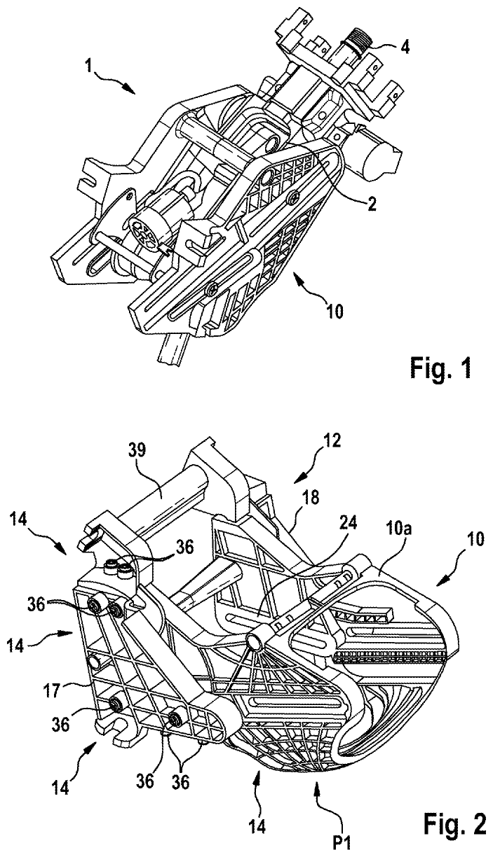

FIG. 1 is a schematic illustration of a steering system for a motor vehicle according to a preferred embodiment of the invention.

The steering system 1 for the motor vehicle has a steering column 4 arranged in a steering column housing 2. The steering system 1 furthermore has a first mounting device 10 in which the steering column housing 2 of the steering column 4 is adjustably mounted.

FIG. 2 is a schematic illustration of the first and second mounting device according to the invention according to the preferred embodiment of the invention.

In FIG. 2, the first mounting device 10 and the second mounting device 12 are, for the sake of clarity, illustrated without the steering column housing and the steering column arranged therein. The first mounting device 10 is mounted adjustably in the second mounting device 12. The second mounting device 12 fastens the first mounting device 10 in a first position P1 by fastening means 14. The first position P1 corresponds to a driving position of the motor vehicle or a rest or park position of the motor vehicle.

The second mounting device 12 has a first side wall 17 and a second side wall 18, which are connected to one another by a connecting element 39. The first mounting device 10 has a first guide element 20 formed adjacent to the first side wall 17 of the second mounting device 12. The second mounting device 12 has a second mounting element 22 which is in engagement with the first mounting element 20. The first mounting device 10 moreover has a third guide element 24 formed adjacent to the second side wall 18 of the second mounting device 12. Furthermore, the second mounting device 12 has a fourth guide element (not shown in FIG. 2) which is in engagement with the third guide element 24.

The fastening means 14 preferably have a plate element (not shown in FIG. 2) and in each case two pressure-exerting elements 36 formed by a screw. In the present embodiment, a total of four fastening means 14 are provided on the first side wall 17, and likewise four fastening means (not shown in FIG. 2) are provided on the second side wall 18 of the second mounting device 12.

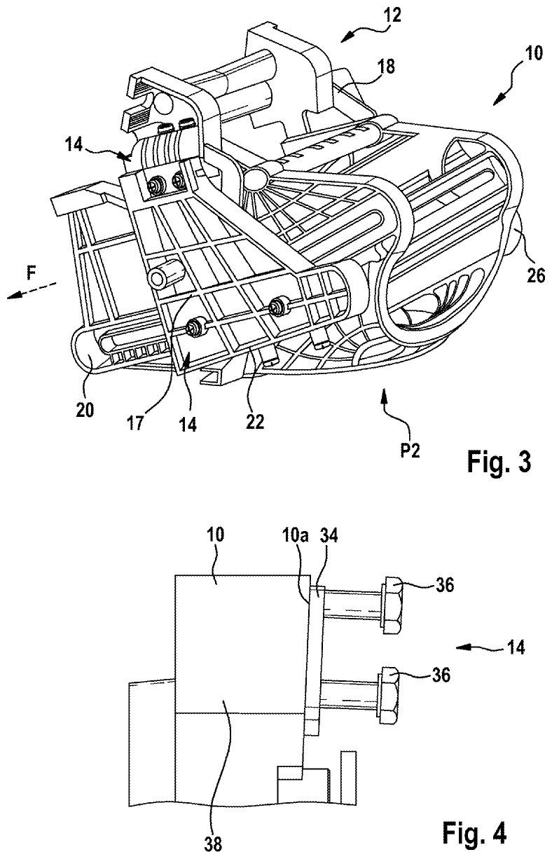

FIG. 3 is a schematic illustration of the first and second mounting device according to the invention according to the preferred embodiment of the invention. The first mounting device 10 is arranged in the second position P2 in the illustration in FIG. 3. The fastening means 14 are preferably designed to, when a force of ≥3500 N acts on the first mounting device 10, release the first mounting device from the fastening in the first position (not shown in FIG. 3), and the first mounting device 10 is movable into the second position P2.

A movement of the first mounting device 10 out of the fastening from the first position (not shown in FIG. 3) into the second position P2 has a movement component in a vehicle longitudinal direction of at least 90 mm.

FIG. 4 is a schematic illustration of fastening means for the fastening of the first mounting device to the second mounting device according to the preferred embodiment of the invention.

The fastening means 14 of the first mounting device 10 have in each case one plate element 34 and two pressure-exerting elements 36. The plate element 34 can be pressed by means of the two pressure-exerting elements 36 against the outer surface 10a of the first mounting device 10. Alternatively, the number of pressure-exerting elements may also have some other suitable number of pressure-exerting elements depending on the structural requirements. The pressure-exerting elements 36 are preferably formed by a screw. As an alternative to this, the pressure-exerting elements 36 may for example be formed by some other suitable device, such as for example a pin element acted on with a spring load, a hydraulic or pneumatic actuating element.

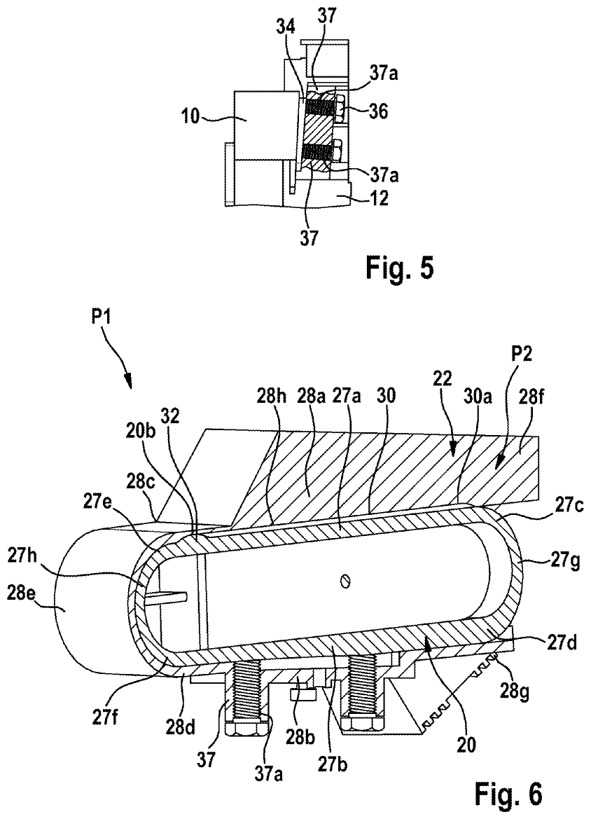

FIG. 5 is a schematic illustration of fastening means for the fastening of the first mounting device to the second mounting device according to the preferred embodiment of the invention.

The two pressure-exerting elements 36, which in the present exemplary embodiment are formed by a screw, are fitted into a respective opening 37 in the second mounting device 12. The openings 37 each have an internal thread 37a. A clamping force of the pressure-exerting elements 36 onto the plate element 34 is thus variable by adjusting or screwing the pressure exerting elements 36, which are in the form of screws, into or out of the opening 37. The release or activation force for the release of the first mounting device from the fastening by the second mounting device preferably amounts to ≥3500 N. Alternatively, the release or activation force may also have some other suitable value, such as for example ≥2000 N.

FIG. 6 is a schematic illustration of a first guide element of the first mounting device and a second guide element of the second mounting device according to the preferred embodiment of the invention.

The first guide element 20 of the first mounting device 10 is formed by a projection which extends substantially perpendicularly from an outer surface 10a of the first mounting device 10. The second guide element 22 of the second mounting device 12 is formed by a receiving means which surrounds the projection. A third guide element (not shown in FIG. 6) of the first mounting device is formed by a projection which extends substantially perpendicularly from the outer surface 10a of the first mounting device 10. The fourth guide element (not shown in FIG. 6) of the second mounting device is formed by a receiving means which surrounds the projection.

The projection is preferably formed by a metal sheet in looped form with two elongate portions 27a, 27b arranged parallel to one another, wherein mutually adjacently arranged first end portions 27c, 27d and second end portions 27e, 27f of the two elongate portions 27a, 27b arranged parallel to one another are connected to one another by respective arcuate portions 27g, 27h.

Alternatively, the projection may for example have some other suitable form, for example an elongate form with only one elongate portion.

The receiving means surrounding the projection has substantially two elongate portions 28a, 28b arranged parallel to one another. Mutually adjacently arranged first end portions 28c, 28d of the two elongate portions 28a, 28b arranged parallel to one another are connected to one another by an arcuate portion 28e. Furthermore, mutually adjacently arranged second end portions 28f, 28g of the two elongate portions 28a, 28b arranged parallel to one another are not connected to one another. It is thus advantageously ensured that the projection of the first mounting device is movable relative to the receiving means, surrounding the projection, of the second mounting device.

Provision is preferably furthermore made whereby one of the two elongate portions arranged parallel to one another, in the present embodiment the portion 28a of the second guide element 22 of the second bearing device 12, has an aperture 30 of substantially elongate form on an inner side 28h arranged adjacent to the first guide element 20 of the first mounting device 10. On the second end portion 27e, on an outer surface 20b of the first guide element 20 of the first mounting device 10, there is preferably formed a projection 32 which extends into the aperture 30. An axial end portion 30a of the aperture 30 forms a stop of the projection 32 during a movement of the first mounting device 10 from the first position P1 into the second position P2.

In the present embodiment, the projection 32 has a triangular form or double wedge form. This advantageously has the effect that, when the first mounting device 10 is arranged in the second position P2, the wedge form of the projection 32 can be clamped against the stop of the aperture 30. The axial end portion 30a of the aperture 30 is preferably likewise formed with a wedge form. The wedge of the projection 32 can thus realize or build up a clamping action with the wedge of the axial end portion 30a of the aperture 30 when the first mounting device 10 is arranged in the second position P2. The first mounting device 10 is thus fixedly clamped in the second position P2, and thus cannot move from the second position P2 back into the first position P1 again in the event of the frontal collision of the motor vehicle.

The same applies to the third guide element and the fourth guide element, which are not illustrated in FIG. 6. At least one of the two elongate portions, arranged parallel to one another, of the fourth guide element of the second mounting device has an aperture of substantially elongate form on an inner side arranged adjacent to the third guide element of the first mounting device. On the first end portion, on an outer surface of the third guide element of the first mounting device, there is formed a projection which extends into the aperture. An axial end portion of the aperture forms a stop of the projection during a movement of the first mounting device from the first position into the second position.

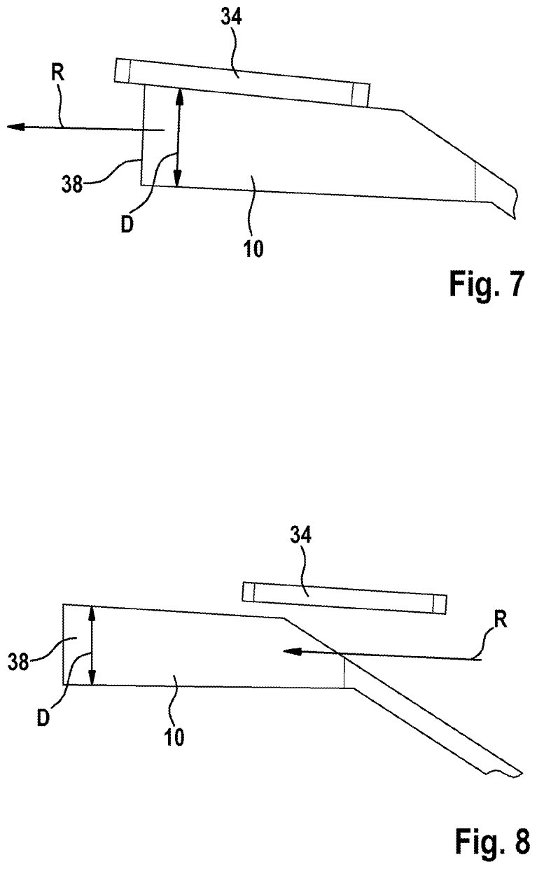

FIG. 7 is a schematic illustration of a wedge form of the first mounting device according to the preferred embodiment of the invention. The outer surface of the first mounting device 10 has a wedge form 38 in the region of the fastening means 14. A thickness D of the wedge form 38 increases in a direction of movement of the first mounting device 10 from the first position toward the second position.

FIG. 8 is a schematic illustration of a wedge form of the first mounting device according to the preferred embodiment of the invention. During the release of the first mounting device 10 from the first position, fastened by the fastening means (not shown in FIG. 8), in the direction of the second position, a gap forms between the first mounting device 10 and the plate element 34 of the fastening means. The mounting device 10 moves away from the plate element 34 in a movement direction R relative to the plate element 34. The first mounting device can thus, after the release from the first position, move toward the second position in unbraked fashion or without further friction caused by the fastening means.

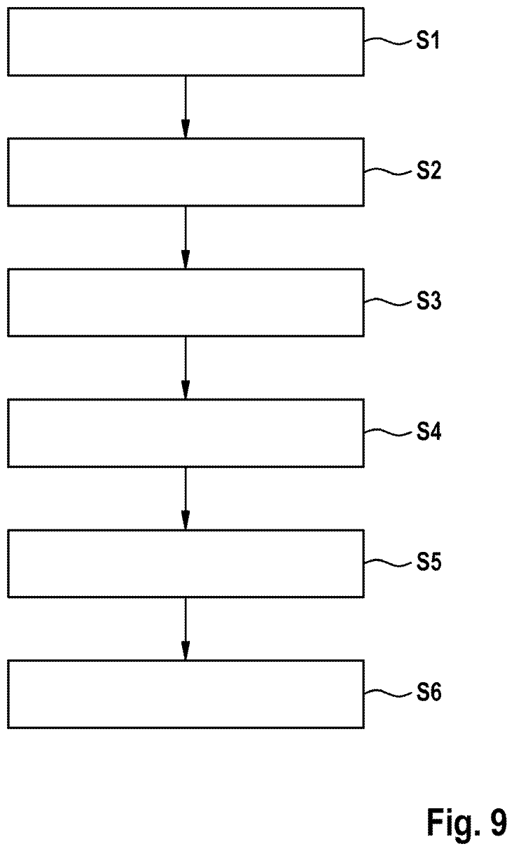

FIG. 9 shows a flow diagram of a method for operating the steering system for the motor vehicle according to the preferred embodiment of the invention.

The method for operating a steering system for a motor vehicle comprises providing Si a steering column arranged in a steering column housing, providing S2 a first mounting device in which the steering column housing of the steering column is adjustably mounted, and providing S3 a second mounting device in which the first mounting device is adjustably mounted.

The method moreover comprises fastening S4 the first mounting device by fastening means of the second mounting device, releasing S5 the first mounting device from a fastening in the first position, when a predefined force acts on the first mounting device, by the fastening means, and moving S6 the first mounting device into a second position.

Although the present invention has been described above on the basis of preferred exemplary embodiments, the invention is not restricted to these, but rather may be modified in a variety of ways. In particular, the invention may be varied or modified in a wide variety of ways without departing from the essence of the invention.

For example, a form, dimension or condition of the components of the steering system may be adapted in accordance with structural requirements.

### LIST OF REFERENCE DESIGNATIONS

1 Steering system
2 Steering column housing
4 Steering column
10 First mounting device
10a Outer surface of the first mounting device
12 Second mounting device
14 Fastening means
17 First side wall
18 Second side wall
20 First guide element
20b Outer surface of the first guide element
22 Second guide element
24 Third guide element
26 Fourth guide element
27a, 27b Elongate portions
27c, 27d First end portions
27e, 27f Second end portions
27g, 27h Arcuate portions
28a, 28b Elongate portions
28c, 28d First end portions
28e Arcuate portion
28f, 28g Second end portions
28h Inner side
30 Aperture
30a Axial end portion of the aperture
32 Projection
34 Plate element
36 Pressure-exerting element
37 Opening
37a Internal thread
38 Wedge form
39 Connecting element
D Thickness
F Force
P1 First position
P2 Second position
R Movement direction

1-14. (canceled)

15. A steering system for a motor vehicle, comprising:
a first mounting device;
a second mounting device fastening the first mounting device in a first position via at least one fastening member, the first mounting device adjustably mounted in the second mounting device;
a steering column housing adjustably mounted in the first mounting device; and
a steering column arranged in the steering column housing,
wherein, when a predefined force acts on the first mounting device, the at least one fastening member releases the first mounting device from a fastening in the first position, and the first mounting device is movable into a second position,
wherein the second mounting device includes a first side wall and a second side wall,
wherein the first mounting device is arranged between the first side wall and the second side wall,
wherein the first mounting device includes a first guide element arranged adjacent to the first side wall of the second mounting device,
wherein the second mounting device further includes a second guide element engaged with the first guide element,
wherein the first mounting device further includes a third guide element arranged adjacent to the second side wall of the second mounting device, and
wherein the second mounting device further includes a fourth guide element engaged with the third guide element.

16. The steering system as claimed in claim 15, wherein:
the first guide element of the first mounting device is defined by a first projection, which extends substantially perpendicularly from an outer surface of the first mounting device;
the second guide element of the second mounting device is defined by a first receiving member, which surrounds the first projection;
the third guide element of the first mounting device is defined by a second projection, which extends substantially perpendicularly from the outer surface of the first mounting device; and
the fourth guide element of the second mounting device is defined by a second receiving member, which surrounds the second projection.

17. The steering system as claimed in claim 16, wherein:
at least one of the first projection and the second projection includes a metal sheet in looped form with two first elongate portions arranged parallel to one another, the two first elongate portions including mutually adjacently arranged first end portions and mutually adjacently arranged second end portions; and
the mutually adjacently arranged first end portions and the mutually adjacently arranged second end portions are arranged parallel to one another and are connected to one another by respective first arcuate portions.

18. The steering system as claimed in claim 17, wherein:
at least one of the first receiving member and the second receiving member includes two second elongate portions arranged parallel to one another, the two second elongate portions including mutually adjacently arranged third end portions and mutually adjacently arranged fourth end portions;
the mutually adjacently arranged third end portions are arranged parallel to one another and are connected to one another by a second arcuate portion; and
the mutually adjacently arranged fourth end portions are arranged parallel to one another and are not connected to one another.

19. The steering system as claimed in claim 18, wherein:
a third projection arranged on the second end portion on an outer surface of the first guide element, wherein:
at least one of the two second elongate portions of the second guide element, arranged parallel to one another includes an aperture of substantially elongate form on an inner side arranged adjacent to the first guide element;
the third projection extends into the aperture; and
the aperture includes an axial end portion defines a stop of the third projection during movement of the first mounting device from the first position into the second position.

20. The steering system as claimed in claim 15, wherein:
each of the at least one fastening member of the first mounting device includes one plate element and at least one pressure-exerting element; and
the at least one pressure-exerting element is configured to press the plate element against the outer surface of the first mounting device.

21. The steering system as claimed in claim 20, wherein:
the at least one pressure-exerting element is defined by a screw fitted into an opening defined in the second mounting device, the opening including an internal thread; and
a clamping force of the plate element onto the outer surface of the first mounting device is variable by adjustment of the screw.

22. The steering system as claimed in claim 20, wherein:
the outer surface of the first mounting device has a wedge form in a region of the at least one fastening member; and
a thickness of the wedge form increases in a direction of movement of the first mounting device from the first position to the second position.

23. The steering system as claimed in claim 15, wherein, when a force of at least 3500 N acts on the first mounting device, the at least one fastening member releases the first mounting device from the fastening in the first position, and the first mounting device is movable into the second position.

24. The steering system as claimed in claim 15, wherein movement of the first mounting device out of the fastening from the first position into the second position has a movement component in a vehicle longitudinal direction of at least 90 mm.

25. The steering system as claimed in claim 15, further comprising:
a connecting element connecting the first side wall and the second side wall of the second mounting device to one another.

26. A method for operating a steering system for a motor vehicle, comprising:
arranging a steering column in a steering column housing;
adjustably mounting a first mounting device in a second mounting device;
adjustably mounting the steering column housing of the steering column in the first mounting device;
fastening the first mounting device via at least one fastening member of the second mounting device;
releasing the first mounting device from a fastening in the first position when a predefined force acts on the first mounting device via the at least one fastening member; and
moving the first mounting device into a second position.

27. A motor vehicle, comprising:
a steering system including:
a first mounting device;
a second mounting device fastening the first mounting device in a first position via at least one fastening member, the first mounting device adjustably mounted in the second mounting device;
a steering column housing adjustably mounted in the first mounting device;
a steering column arranged in the steering column housing,
wherein, when a predefined force acts on the first mounting device, the at least one fastening member releases the first mounting device from a fastening in the first position, and the first mounting device is movable into a second position,
wherein the second mounting device includes a first side wall and a second side wall,
wherein the first mounting device is arranged between the first side wall and the second side wall,
wherein the first mounting device includes a first guide element arranged adjacent to the first side wall of the second mounting device,
wherein the second mounting device further includes a second guide element engaged with the first guide element,
wherein the first mounting device further includes a third guide element arranged adjacent to the second side wall of the second mounting device, and
wherein the second mounting device further includes a fourth guide element engaged with the third guide element,
wherein the second mounting device is installed positionally fixedly in the motor vehicle.
